(19) United States
(12) Patent Application Publication
(10) Pub. No.: US 2010/0255831 A1
(43) Pub. Date: Oct. 7, 2010

(54) DETERMINING DELAY IN A COMMUNICATIONS SYSTEM

(75) Inventors: Mohammed Ataur Rahman Shuman, San Diego, CA (US); Ashutosh Aggarwal, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/750,253

(22) Filed: Mar. 30, 2010

Related U.S. Application Data
(60) Provisional application No. 61/167,432, filed on Apr. 7, 2009.

(51) Int. Cl. H04W 24/00

(52) U.S. Cl. 455/423

(57) ABSTRACT

In an embodiment, a first terminal detects a request to initiate a call session (e.g., a VoIP session) from the first terminal to a second terminal, stores first time information indicative of when the request to initiate the call session is detected and transmits a call invite message to the second terminal. The first terminal receives a call answer from the second terminal in response to the call invite message, and stores second time information indicative of when the call answer is received. The first terminal sends Post Dial Delay (PDD) information based on the first and second time information. A server receives the PDD information within a signaling message defined by a communication protocol associated with the call session or the information needed to determine the PDD of the call session.

### CLAIM OF PRIORITY UNDER 35 U.S.C. §119

The present Application for Patent claims priority to Provisional Application No. 61/167,432 entitled “DETERMINING DELAY IN A COMMUNICATIONS SYSTEM” filed Apr. 7, 2009, and assigned to the assignee hereof and hereby expressly incorporated by reference herein.

### BACKGROUND OF THE INVENTION

1. Field of the Invention

Embodiments of the present invention are directed to determining delay in a communications system, and more particularly to determining a Post-Dial-Delay (PDD) for a call session in the communications system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xEV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

In telecommunication systems, voice over internet protocol (VoIP) capabilities are becoming popular with service sectors and consumers. VoIP is a full-duplex protocol (i.e., allows communication in both directions) that is optimized for the transmission of voice through the Internet or other packet-switched networks.

A relevant performance metric associated with VoIP communications corresponds to how quickly a call can be established between two VoIP terminals (or one VoIP terminal and a land-line or wireless phone if the VoIP packets are translated to other networks), which is referred to as Post Dial Delay (PDD). PDD corresponds to the time differential between (i) a user of a VoIP terminal attempting to initiate a call (e.g., by dialing a last digit of a phone number and pressing a SEND button) and (ii) the VoIP terminal outputting a ringtone (or busy signal or other type of call response). Alternatively, the time differential can correspond to the time between (i) the call initiation attempt and (ii) a time when an answer to the call invite has been received (e.g., which then prompts the phone to output the ringtone). In any case, the time differential between the ringtone output and receipt of the call answer message is relatively small.

Conventionally, to compile PDD data, a logging apparatus (e.g., a laptop computer) is connected to a test VoIP terminal for logging the PDD data. However, only a relatively small number of VoIP terminals can be configured as testers without incurrent significant expenses (e.g., due to hardware costs, personnel costs, etc.), complexity regarding the process for uploading the logs to a network management server, and a time-lag between the PDD being logged at the logging apparatus and the uploading of the logged PDD information to the network management server.

### SUMMARY

In an embodiment, a first terminal detects a request to initiate a call session (e.g., a VoIP session) from the first terminal to a second terminal, stores first time information indicative of when the request to initiate the call session is detected and transmits a call invite message to the second terminal. The first terminal receives a call answer from the second terminal in response to the call invite message, and stores second time information indicative of when the call answer is received. The first terminal sends Post Dial Delay (PDD) information based on the first and second time information. A server receives the PDD information within a signaling message defined by a communication protocol associated with the call session or the information needed to determine the PDD of the call session.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a communications network in accordance with at least one embodiment of the invention.

FIG. 2 illustrates a conventional manner of calculating and logging Post-Dial-Delays (PDDs) in the network of FIG. 1.

FIG. 3 illustrates a conventional PDD test device arrangement that includes a Voice over Internet Protocol (VoIP) terminal, a logging apparatus and a connection connecting the VoIP terminal and logging apparatus.

FIG. 4 illustrates a PDD information reporting process according to an embodiment of the present invention.

FIGS. 5A and 5B illustrate different ways PDD information can be transmitted and post-processed according to embodiments of the present invention.

FIG. 6 illustrates another PDD information reporting process according to an embodiment of the present invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

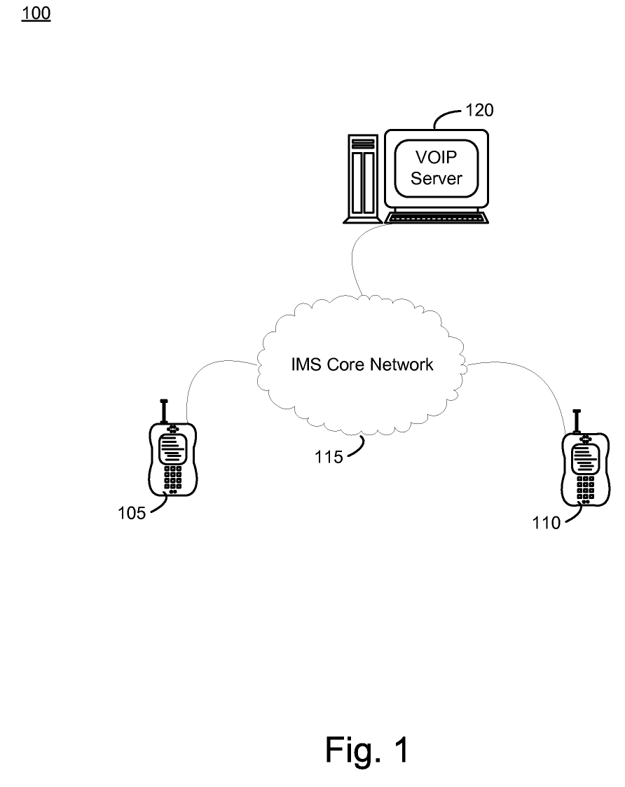

FIG. 1 is a diagram of a communications network 100 in accordance with at least one embodiment of the invention. As shown, the communications network 100, or system, includes VoIP terminals 105 and 110. As used herein, a VoIP terminal can be any communications device capable of supporting VoIP communication protocols. VoIP terminals can include mobile devices (e.g., laptop computers, cellular phones, PDAs, etc.) or fixed devices (e.g., desktop computers, etc.). Thus, while the communications system 100 can be embodied as a wireless communications system, the communications system 100 can also be embodied, at least partially, as a wired communications system.

Referring to FIG. 1, VoIP terminals 105 and 110 are connected via an IP Multimedia Subsystem (IMS) core network 115. The IMS core network 115 is an architectural framework for delivering internet protocol (IP) multimedia to users (e.g., mobile users). While the IMS core network 115 can be associated with mobile users, in other embodiments of the invention, the IMS core network 115 can also be accessed by VoIP terminals that are stationary, such as desktop computers. Referring to FIG. 1, the IMS core network 115 is connected to a VoIP server 120. The VoIP server 120 manages VoIP communications between one or more VoIP terminals, such as VoIP terminals 105 and 110, and potentially between a VoIP terminal and a cellular phone or landline phone.

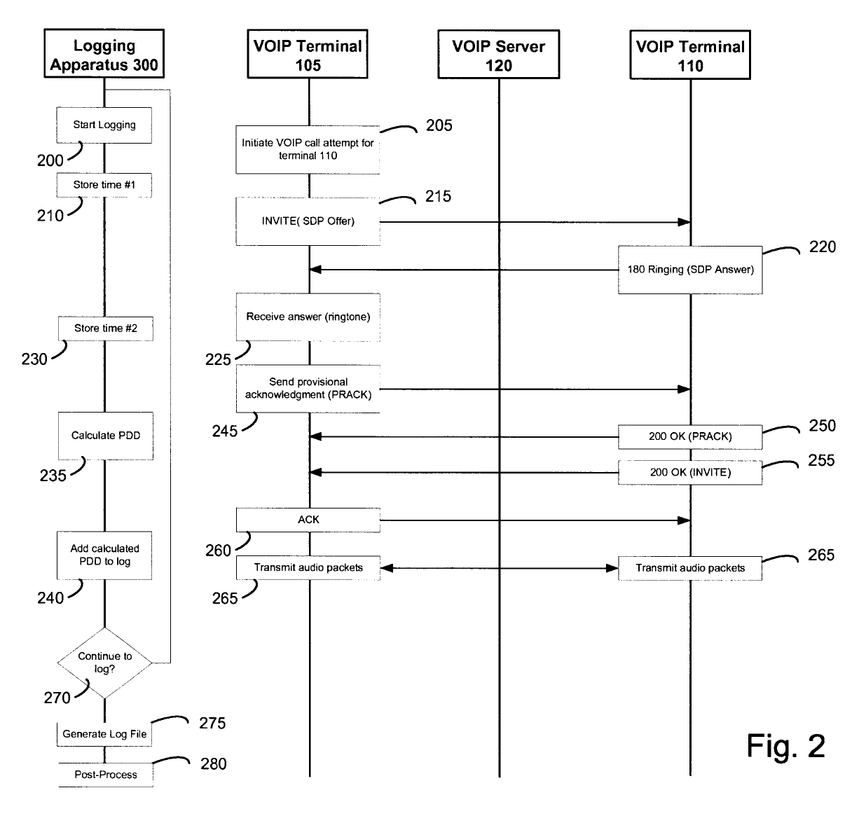

FIG. 2 illustrates a conventional manner of calculating and logging PDDs for VOIP calls in the communications system 100 of FIG. 1. As discussed in the Background section, PDD corresponds to the time differential between (i) a user of a VoIP terminal attempting to initiate a call (e.g., by dialing a last digit of a phone number and pressing a SEND button) and (ii) the VoIP terminal outputting a ringtone (or busy signal or other type of call response). Alternatively, the time differential can correspond to the time between (i) the call initiation attempt and (ii) a time when an answer to the call invite has been received (e.g., which then prompts the phone to output the ringtone). In any case, the time differential between the ringtone output and receipt of the call answer message is relatively small.

As will be appreciated by one of ordinary skill in the art, it can be useful in VoIP applications to compile data indicative of PDD because he PDD is the time the user must wait before the call can begin. The conventional manner of gathering PDD information, described below in FIG. 2, is by distributing test phones, which are VoIP terminals connected to a logging apparatus, that log the PDD information.

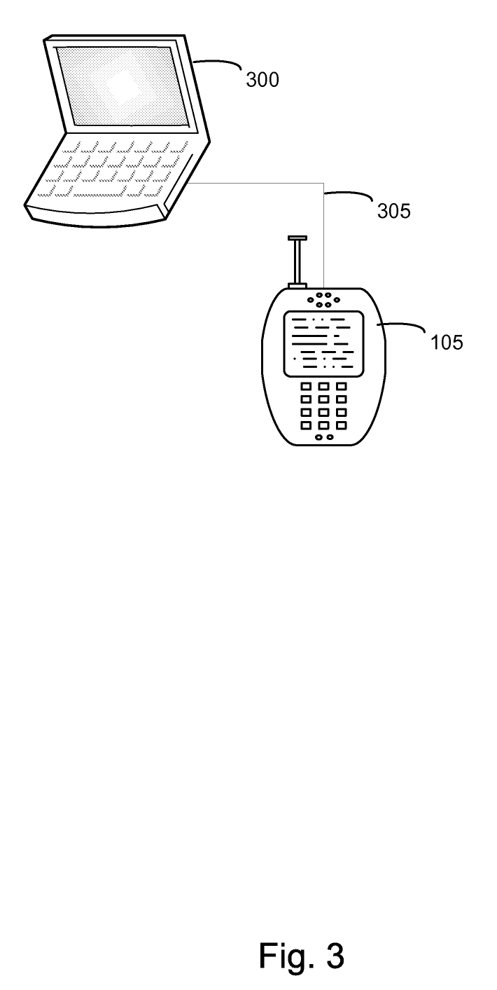

Accordingly, FIG. 2 is described below as implemented within the system 100 of FIG. 1 with the VoIP terminals 105 and 110 of FIGS. 1 and 3. Referring to FIG. 3, the VoIP terminal 105 is connected to a logging apparatus 300 via a connection 305. In an example, the logging apparatus 300 can be a desktop or laptop computer. The connection 305 that connects the logging apparatus 300 to the VoIP terminal 105 can be any type of well-known connection, such as USB, Bluetooth, a proprietary connection, etc.

Referring to FIG. 2, the logging apparatus 300 starts logging the PDDs for VoIP calls made by the VoIP terminal 105, and thereby monitors the VoIP terminal 105 and waits for a user of the VoIP terminal 105 to initiate a call attempt or request a call session, 200. In 205, the user of the initiates a VoIP call attempt to VoIP terminal 110. The logging apparatus 300 detects the call attempt initiation (e.g., the pressing of a last phone number digit), and stores a first timestamp that approximates the time of the detected VoIP call initiation, 210. The VoIP terminal 105 transmits a call invite message (e.g., a Session Description Protocol (SDP) offer) to VoIP terminal 110 via the IMS core network 115 and VoIP server 120, 215.

After the VoIP terminal 110 receives the call invite message, the VoIP terminal 110 transmits a call answer (e.g., a 180 ringing message, or SDP answer) to VoIP terminal 105 via the IMS core network 115 and VoIP server 120, 220. The VoIP terminal 105 receives the call answer and outputs a ringtone, 225. Upon a detection that the VoIP terminal 105 has received the call answer, or alternatively upon a detection that the VoIP terminal 105 has output a ringtone, the logging apparatus 300 stores a second timestamp that approximates the time of the detection, 230, calculates the PDD for the call by taking a difference between the first and second timestamps, 235 and adds the calculated PDD to a PDD log maintained for the VoIP terminal 105, 240. Alternatively, the calculating step of 235 need not be performed at the logging apparatus 300. In this case, step 235 may merely add the recorded time stamps to the log, and the calculation of the PDD can be offloaded to the VoIP server 120, for example, or to whichever entity is responsible for post-processing the log file.

The VoIP terminal 105 sends a provisional acknowledgment (PRACK) to the VoIP terminal 110 via the IMS core network 115 and VoIP server 120 to acknowledge receipt of the call answer, 245, and the VoIP terminal 110 responds with signaling messages (e.g., 200 OK (PRACK) and 200 OK (INVITE)) to acknowledge that the PRACK has been received and that VoIP terminal 110 is ready to begin speaking (e.g., a user of VoIP terminal 110 has gone ‘off-hook’) 250, 255. The VoIP terminal 105 sends an acknowledgement (ACK) in response to the signaling messages, 260, and VoIP terminals 105 and 110 then engage in a VoIP session by exchanging audio packets, 265

In 270, the logging apparatus 300 determines whether to continue to log PDDs for VoIP calls of the VoIP terminal 105. If the logging apparatus 300 (or a user of the logging apparatus 300) determines to continue logging, the process returns to 200, and the logging apparatus 300 continues logging and waits for a next VoIP call initiation attempt. Accordingly, it will be appreciated that PDDs for a series of VoIP calls can be captured within a single log session. Otherwise, if the logging apparatus 300 determines to cease logging, the logging apparatus 300 generates a log file, 275, and performs post-processing on the log file, 280. For example, in the post-processing of 280, the VoIP server 120 one or more output metrics of interest are generated, which may later be uploaded to an entity that can adjust system parameters based on the output metrics (e.g., a network management server (not shown)). For example, the post-processing can include populating a histogram type counter, generating a cumulative distribution function and/or generating any other output metric of interest based on the logged PDD samples.

As will be appreciated by one of ordinary skill in the art, deploying VoIP terminals along with logging apparatuses throughout a communications system to gather data related to PDD is limited in a number of respects. For example, only a relatively small number of VoIP terminals coupled with logging apparatuses can be deployed without significant expenses (e.g., due to hardware costs, personnel costs, etc.), there is complexity regarding the process for uploading the log files and/or post-processed output metrics to the VoIP server 120, and there is also a time-lag between the PDD being logged at the logging apparatus 300 and the output metrics being collected such that operating or system parameters of the VoIP communications system can be adjusted accordingly (e.g., at a network management server).

### PDD Reporting According to Embodiments of the Present Invention

As described above, PDD information is conventionally obtained via the deployment of specialized logging equipment, which increases the complexity, expense and delay associated with obtaining the PDD information. As will now be described, embodiments of the present invention are directed to PDD information reporting from any VoIP terminal within the communications system 100 without the need for specialized equipment.

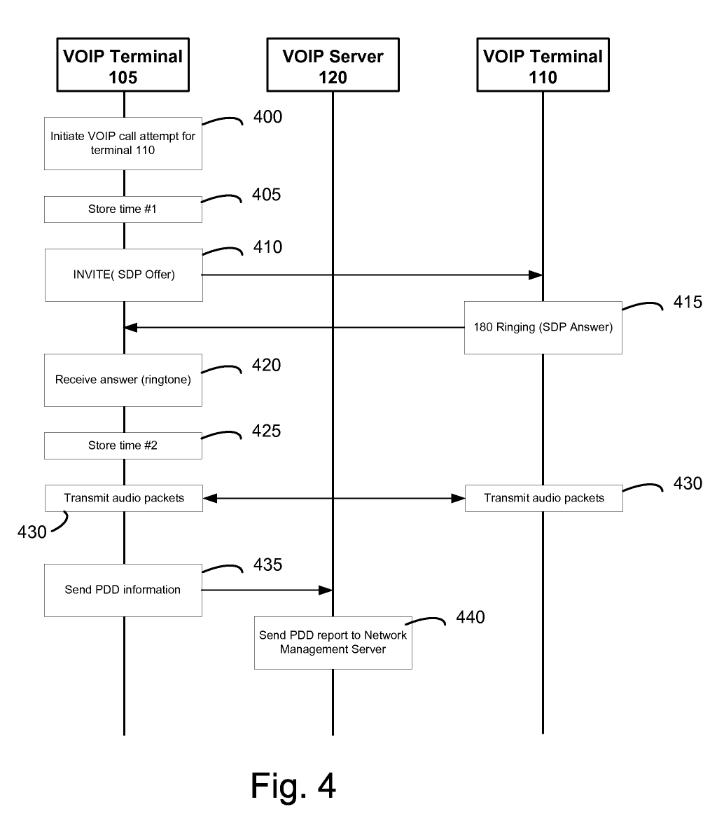

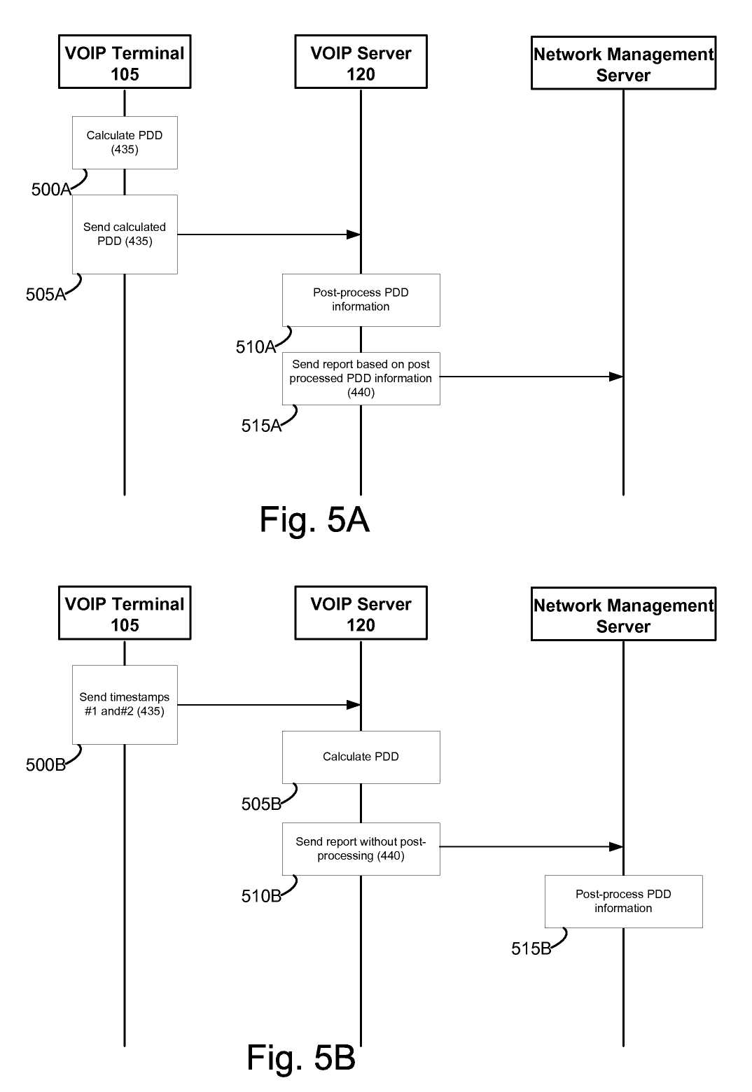

FIG. 4 illustrates a PDD information reporting process according to an embodiment of the present invention. Referring to FIG. 4, a user of the VoIP terminal 105 initiates an attempt to call VoIP terminal 110, 400. In contrast to FIGS. 2 and 3, the VoIP terminal 105 of FIG. 5 need not be connected to a separate logging apparatus. The VoIP terminal 105 detects the initiation of the call attempt (e.g., also referred to as requesting a call session, such as by dialing a last digit of a phone number and pressing a SEND button), and stores a first timestamp that approximates the time of the detection, 405. The VoIP terminal 105 transmits a call invite message (e.g., a Session Description Protocol (SDP) offer) to VoIP terminal 110 via the IMS core network 115 and VoIP server 120, 410.

After the VoIP terminal 110 receives the call invite message, the VoIP terminal 110 transmits a call answer (e.g., a 180 ringing message, or SDP answer) to VoIP terminal 105 via the IMS core network 115 and VoIP server 120, 415. The VoIP terminal 105 receives the call answer and outputs a ringtone, 420. Upon a detection that the VoIP terminal 105 has received the call answer, or alternatively upon a detection that the VoIP terminal 105 has output a ringtone, the VoIP terminal 105 stores a second timestamp that approximates the time of the detection, 425.

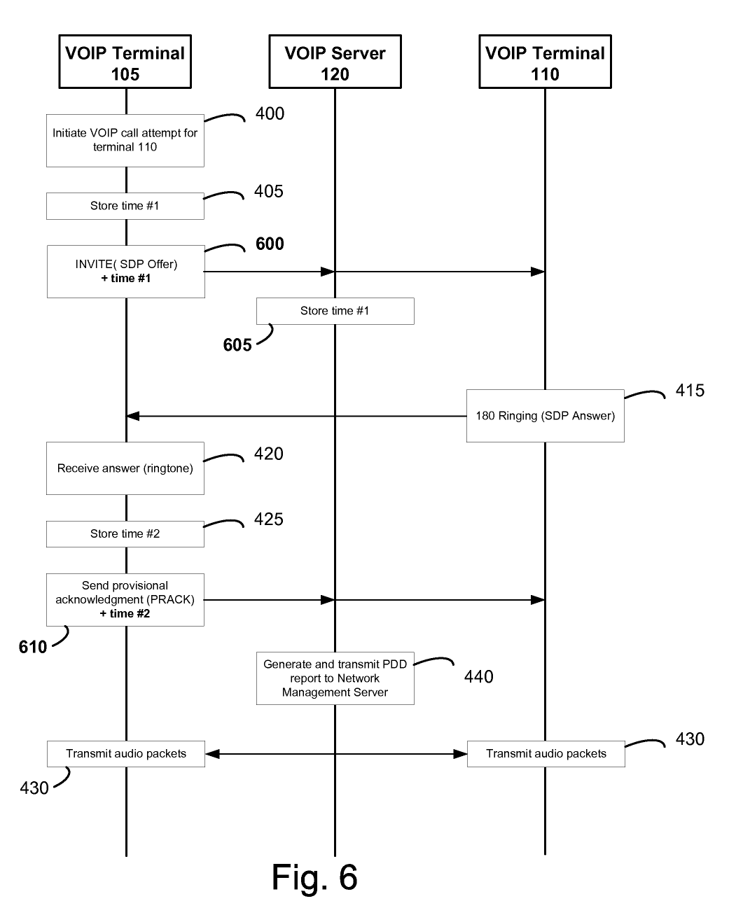

After storing the second timestamp, VoIP terminals 105 and 110 engage in a VoIP session by exchanging audio packets, 430. In an example, the VoIP session of 430 occurs after the VoIP terminal 105 sends a provisional acknowledgment (PRACK) to the VoIP terminal 110, the VoIP terminal 110 responds with signaling messages (e.g., 200 OK (PRACK) and 200 OK (INVITE)) to acknowledge that the PRACK has been received and that VoIP terminal 110 is ready to begin speaking (e.g., a user of VoIP terminal 110 has gone ‘off-hook’), and the VoIP terminal 105 sends an acknowledgement (ACK) in response to the signaling messages (e.g., as in 245, 250, 255 and 260 of FIG. 2). These steps have been omitted from FIG. 4 for the sake of brevity, and also because, in at least one embodiment, the messages described in FIG. 2 at 245 through 260 can be used to send PDD information, as will be described in greater detail below with respect to FIGS. 5A, 5B and 6.

The VoIP terminal 105 sends PDD information, based on the stored first and second timestamps, to the VoIP server 120, 435. The PDD information can be, in an example, an actual or mapped PDD value (e.g., the second timestamp minus the first timestamp) that is calculated at the VoIP terminal 105 (e.g., see FIG. 5A), or the first and second timestamps may be sent without a calculation of the PDD (e.g., see FIG. 5B).

In an example, the PDD information transmitted in 435 may be included within the PRACK transmitted from the VoIP terminal 105 to the VoIP terminal 110. In this example, the PDD information can be either (i) a combination of the first and second timestamps or (ii) a calculation of the PDD. Also, while the PDD information transmission of 435 is illustrated as occurring after the user of the VoIP terminal 105 begins VoIP session in 430, it will be appreciated that the PRACK may be sent relatively soon after receiving the call answer (e.g., because audio packets are exchanged), and as such may occur before 430 in an example.

In an alternative example, the PDD information can be transmitted at a later time, such as at the end of the VoIP call, which may permit the PDD information to be bundled with additional information (e.g., call duration, etc.). In another example, irrespective of when the PDD information is transmitted, the PDD information may be bundled with additional information, such as information specific to the VoIP terminal 105 (e.g., phone type, firmware version, installed applications, whether the VoIP terminal 105 communicates via a wired or wireless connection, etc.) and/or radio information (e.g., Serving sector ID, channel conditions at the VoIP terminal 105, etc.). After the PDD information is transmitted in 435, the VoIP terminal 105 need not retain the stored first and second timestamps, which may then be erased from memory.

In another example, if the PDD information is transmitted as a calculated PDD value, the PDD information may be encoded with a given mapping protocol to conserve bandwidth. Table 1 (below) illustrates an example mapping protocol for the transmission of a PDD value.

TABLE 1
Example Mapping Protocol for PDD Value Transmission

| PDD value range | Code |
|---|---|
| 0-200 ms | 00 |
| 200-600 ms | 01 |
| 600 ms-2 s | 10 |
| Timeout (no tone established) | 11 |

As shown in Table 1 (above), the PDD information can be conveyed to the VoIP server 120 with two bits that correspond to three (3) PDD value ranges and a timeout condition, in an example. As will be appreciated, if more precision is required by the VoIP server 120, the number of bits and PDD value ranges can be augmented. Also, while not shown, in another example, if the PDD information is transmitted as first and second timestamps, each of the timestamps may be encoded with a given mapping protocol to conserve bandwidth (e.g., such that a reduced number of bits indicates a given range of time).

After the PDD information is transmitted in 435, the VoIP server 120 receives the PDD information and then generates and sends a PDD report, 440, to a network management server (not shown in FIG. 4), as will now be described in greater detail with respect to FIGS. 5A and 5B. Alternatively, instead of the “push” implementation wherein the VoIP server 120 initiates report generation and transmission to the network management server, a “pull” implementation can be deployed wherein the VoIP server 170 generates and forwards the report (or any other requested information) in response to a request from the network management system.

Referring to FIG. 5A, the VoIP terminal 105 calculates the PDD of the VoIP call, 500A, and sends the calculated PDD to the VoIP server 120 (e.g., via a mapping protocol as in Table 1), 505A. As will be appreciated, 500A and 505A of FIG. 5A correspond to 435 of FIG. 4. In 510A, the VoIP server 120 performs post-processing upon the received PDD information (e.g., as in 280 of FIG. 2) to generate one or more output metrics of interest (e.g., a histogram type counter, a cumulative distribution function, etc.). The VoIP server 120 then generates a report based on the post-processed PDD information, and transmits the generated report to the network management server, 515A. Again, the report transmission of 515A may alternatively be triggered by a request from the network management server (e.g., “pull” instead of “push”), and need not be independently performed by the VoIP server 120 without such a request in at least one embodiment. The network management server may then adjust system parameters based on the PDD feedback provided in the generated report.

Further, additional information such as serving sector, system load, phone type, access technology can be leveraged by the VoIP server 120 or the network management system to better interpret the system performance. This information can be, for example, acquired at the VoIP server 120 and passed to the network management system via the report discussed above.

Referring to FIG. 5B, the VoIP terminal 105 sends the first and second timestamps to the VoIP server 120 (e.g., as actual values, as bits that are mapped to a PDD range, etc.), 500B. As will be appreciated, 500B of FIG. 5B corresponds to 435 of FIG. 4. In 505B, the VoIP server 120 calculates the PDD based on the first and second timestamps, generates a report based on the calculated PDD without post-processing, and transmits the generated report to the network management server, 510A. Again, the report transmission of 510A may alternatively be triggered by a request from the network management server (e.g., “pull” instead of “push”), and need not be independently performed by the VoIP server 120 without such a request in at least one embodiment. The network management server may then perform the post-processing based on the calculated PDD, 515B, and if necessary, adjusts system parameters based on post-processing.

Above, FIG. 5A describes an embodiment where the PDD is calculated at the VoIP terminal 105, and post-processing occurs at the VoIP server 120, whereas FIG. 5B describes an embodiment where the PDD is calculated at the VoIP server 120, and post-processing occurs at the network management server. In another example, however, the PDD can be calculated at the VoIP terminal 105 while post-processing can occur at the network management server, or the PDD can be calculated at the VoIP server 120 and post-processing may also occur at the VoIP server 120.

In the description of FIG. 4 above, one way by which the VoIP terminal 105 may transmit PDD information in 435 is via the transmission of first and second timestamps, which are indicative of the initiation of the VoIP call attempt of 400 and call answer receipt of 420, respectively. In FIG. 4, the transmission of the first and second timestamps was described as being included within the transmission of the PDD information at 435, which occurs sometime after the second timestamp is stored in 425 (e.g., in a PRACK message, at the end of the VoIP call, etc.). However, the first and second timestamps need not be bundled together in step 435 of FIG. 4.

Accordingly, FIG. 6 illustrates a modification to the process of FIG. 4, wherein the first timestamp is transmitted within the VoIP call invite message of 600 (e.g., corresponding to the VoIP call invite message of 410 in FIG. 4), with the first timestamp being extracted from the PRACK message and stored at the VoIP server 120 in 605. The second timestamp can be transmitted within the PRACK message of 610 (e.g., corresponding to the PRACK message of 535 of FIG. 5). The first and second timestamps need not be retained after their respective transmission, and can be erased from memory at the VoIP terminal 105 after transmission. Also, while FIG. 6 illustrates the first timestamp being transmitted within the VoIP call invite message and the second timestamp being transmitted within the PRACK message, it will be appreciated that the first and second timestamps need not be included within these particular signaling messages in other embodiments of the invention. For example, the second timestamp may be transmitted at the end of the VoIP call (e.g., with additional call information that becomes available later, such as VoIP call duration, etc.), the first timestamp may be transmitted within the PRACK, etc. Thus, the PDD information transmission of 435 in FIG. 4 is partitioned in FIG. 6, and occurs at 600, 605 and 610 collectively.

As will be appreciated by one of ordinary skill in the art, the PDD information reporting protocols according to embodiments of the present invention permit any VoIP terminal operating in accordance with those protocols to inform the VoIP server 120 of PDD values via signaling messages performed in-network, contrasted with separate logging apparatuses having to separately upload the logged PDD information out of network (e.g., via non-VOIP communication protocols). Also, the PDD information can, in some instances, be provided from the VoIP terminal the VoIP server in near real-time, which increases the responsiveness of the network management server in adapting to the PDD feedback. The hardware and personnel costs associated with the process of FIGS. 2 and 3 can likewise be reduced.

Further, while above-described embodiments are directed to an audio VoIP session, it will be appreciated that other embodiments can be directed to any type of media session (e.g., video, txt, based on session initiation protocol (SIP), etc.). Thus, the examples directed to VoIP given above are provided for illustrative purposes only, and other embodiments of the invention can be directed to non-voice or non-audio communication, or communication including audio and other media.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of reporting Post-Dial-Delay (PDD) information within a communications network, comprising:
detecting a request to initiate a call session from a first terminal to a second terminal;
storing first time information indicative of when the request to initiate the call session is detected;
transmitting a call invite message to the second terminal;
receiving a call answer from the second terminal in response to the call invite message;
storing second time information indicative of when the call answer is received; and
sending, from the first terminal, PDD information based on the first and second time information.

2. The method of claim 1, wherein the detected request corresponds to a user of the first terminal dialing a phone number of the second terminal.

3. The method of claim 1, wherein the received call answer corresponds to a ringtone.

4. The method of claim 3, wherein the second time information indicates the time the first terminal receives a message instructing the first terminal to play the ringtone.

5. The method of claim 3, wherein the second time information indicates the time at which the ringtone begins playing.

6. The method of claim 1, wherein the sending step sends the first and second time information as the PDD information.

7. The method of claim 6, wherein the sending step sends the first and second time information concurrently.

8. The method of claim 6, wherein the sending step sends the first and second time information during call setup.

9. The method of claim 8, further comprising:
transmitting a provisional acknowledgment (PRACK) to the call answer,
wherein the sending step sends the first and second time information within the PRACK.

10. The method of claim 6, wherein the sending step sends the first and second time information at different times.

11. The method of claim 10, wherein the first time information is sent within the call invite message.

12. The method of claim 11, further comprising:
transmitting a provisional acknowledgment (PRACK) to the call answer,
wherein the sending step sends the second time information within the PRACK.

13. The method of claim 1, further comprising:
calculating the PDD at the first terminal based on the first and second time information,
wherein the sending step sends the calculated PDD as the PDD information.

14. The method of claim 13, further comprising:
transmitting a provisional acknowledgment (PRACK) to the call answer,
wherein the sending step sends the calculated PDD within the PRACK.

15. The method of claim 13, wherein the sending step further includes:
encoding the calculated PDD with a mapping protocol that indicates one of a plurality of delay ranges.

16. The method of claim 1, wherein the sending step sends the PDD information within one or more signaling messages of a communication protocol that supports the call session.

17. The method of claim 1, wherein the call session is a Voice over Internet Protocol (VoIP) session.

18. The method of claim 17, wherein the first terminal is a VoIP terminal and the second terminal is not a VoIP terminal.

19. The method of claim 17, wherein the first and second terminals are VoIP terminals.

20. The method of claim 1, wherein one or more of the first and second terminals are wireless devices.

21. A method of acquiring Post-Dial-Delay (PDD) information within a communications network, comprising:
receiving at least one message from a first terminal that indicates PDD information related to a call session between the first terminal and a second terminal, the at least one message being a signaling message defined by a communication protocol associated with the call session;
forwarding the at least one message to the second terminal; and
extracting, from the at least one message, the PDD information.

22. The method of claim 21, wherein the first terminal initiates the call session, the PDD information includes first time information and second time information, the first time information based on when a request to initiate the call session is detected at the first terminal, and the second time information based on when a call answer message is received from the second terminal at the first terminal.

23. The method of claim 22, further comprising:
transferring a call invite from the first terminal to the second terminal;
transferring a call answer in response to the call invite from the second terminal to the first terminal; and
transferring a provisional acknowledgment (PRACK) to the call answer from the first terminal to the second terminal.

24. The method of claim 23, wherein the receiving step receives the at least one message during call setup.

25. The method of claim 24, wherein the at least one message corresponds to the PRACK, such that the extracting step extracts the first and second time information from the PRACK.

26. The method of claim 24, wherein the at least one message corresponds to the call invite and the PRACK, such that the extracting step extracts the first information from the call invite and the second time information from the PRACK.

27. The method of claim 22, wherein the at least one message corresponds to a single message and the extracting step extracts the first and second time information from the single message.

28. The method of claim 22, wherein the at least one message corresponds to multiple messages and the extracting step extracts the first and second time information from different of the multiple messages.

29. The method of claim 22, further comprising:
calculating the PDD of the call session based on the first and second time information.

30. The method of claim 21, wherein the received PDD information corresponds to a calculated PDD of the call session that is calculated at the first terminal.

31. The method of claim 30, wherein the calculated PDD is encoded with a mapping protocol that indicates one of a plurality of delay ranges.

32. The method of claim 21, wherein the at least one message corresponds to one or more signaling messages of a communication protocol that supports the call session.

33. The method of claim 21, further comprising:
generating a PDD report based on the received PDD information; and
sending the PDD report to a network management server.

34. The method of claim 33, the generating and sending the PDD report steps are performed upon receipt of the PDD information.

35. The method of claim 33, wherein the generating and sending the PDD report steps are performed in response to a request for PDD information from the network management server.

36. The method of claim 33, wherein the generating step includes post-processing the received PDD information.

37. The method of claim 36, wherein post-processing the received PDD information includes generating one or more output metrics that are used by the network management server in evaluating the wireless communications network.

38. The method of claim 33, wherein the generating step does not include post-processing the received PDD information, such that the network management server is responsible for post-processing the received PDD information.

39. The method of claim 21, wherein the call session is a Voice over Internet Protocol (VoIP) session.

40. The method of claim 21, wherein the first terminal is a VoIP terminal and the second terminal is not a VoIP terminal.

41. The method of claim 21, wherein the first and second terminals are VoIP terminals.

42. The method of claim 21, wherein one or more of the first and second terminals are wireless devices.

43. A first terminal within a communications network, comprising:
means for detecting a request to initiate a call session from the first terminal to a second terminal;
means for storing first time information indicative of when the means for detecting detects the request to initiate the call session;
means for transmitting a call invite message to the second terminal;
means for receiving a call answer from the second terminal in response to the call invite message;
means for storing second time information indicative of when the means for receiving receives the call answer; and
means for sending, from the first terminal, Post-Dial-Delay (PDD) information based on the first and second time information.

44. The first terminal of claim 43, wherein the means for sending sends the first and second time information as the PDD information.

45. The first terminal of claim 43, further comprising:
means for calculating the PDD at the first terminal based on the first and second time information,
wherein the means for sending sends the calculated PDD as the PDD information.

46. The first terminal of claim 43, wherein the means for sending sends the PDD information within one or more signaling messages of a communication protocol that supports the call session.

47. A server within a communications network, comprising:
means for receiving at least one message from a first terminal that indicates Post Dial Delay (PDD) information related to a call session between the first terminal and a second terminal, the at least one message being a signaling message defined by a communication protocol associated with the call session;
means for forwarding the at least one message to the second terminal; and
means for extracting, from the at least one message, the PDD information.

48. The server of claim 47, wherein the first terminal initiates the call session, the PDD information includes first time information and second time information, the first time information based on when a request to initiate the call session is detected at the first terminal, and the second time information based on when a call answer message is received from the second terminal at the first terminal.

49. The server of claim 48, further comprising:
means for calculating the PDD of the call session based on the first and second time information.

50. The server of claim 47, wherein the received PDD information corresponds to a calculated PDD of the call session that is calculated at the first terminal.

51. The server of claim 47, wherein the at least one message corresponds to one or more signaling messages of a communication protocol that supports the call session.

52. A first terminal within a communications network, comprising:
logic configured to detect a request to initiate a call session from the first terminal to a second terminal;
logic configured to store first time information indicative of when the logic configured to detect detects the request to initiate the call session;
logic configured to transmit a call invite message to the second terminal;
logic configured to receive a call answer from the second terminal in response to the call invite message;
logic configured to store second time information indicative of when the logic configured to receive receives the call answer; and
logic configured to send, from the first terminal, Post-Dial-Delay (PDD) information based on the first and second time information.

53. The first terminal of claim 52, wherein the logic configured to send sends the first and second time information as the PDD information.

54. The first terminal of claim 52, further comprising:
logic configured to calculate the PDD at the first terminal based on the first and second time information,
wherein the logic configured to send sends the calculated PDD as the PDD information.

55. The first terminal of claim 52, wherein the logic configured to send sends the PDD information within one or more signaling messages of a communication protocol that supports the call session.

56. A server within a communications network, comprising:
logic configured to receive at least one message from a first terminal that indicates Post Dial Delay (PDD) information related to a call session between the first terminal and a second terminal, the at least one message being a signaling message defined by a communication protocol associated with the call session;
logic configured to forward the at least one message to the second terminal; and
logic configured to extract, from the at least one message, the PDD information.

57. The server of claim 56, wherein the first terminal initiates the call session, the PDD information includes first time information and second time information, the first time information based on when a request to initiate the call session is detected at the first terminal, and the second time information based on when a call answer message is received from the second terminal at the first terminal.

58. The server of claim 57, further comprising:
logic configured to calculate the PDD of the call session based on the first and second time information.

59. The server of claim 56, wherein the received PDD information corresponds to a calculated PDD of the call session that is calculated at the first terminal.

60. The server of claim 56, wherein the at least one message corresponds to one or more signaling messages of a communication protocol that supports the call session.

61. A computer-readable medium comprising instructions, which, when executed by a first terminal within a wireless communications network, cause the first terminal to perform operations, the instructions comprising:
program code to detect a request to initiate a call session from the first terminal to a second terminal;
program code to store first time information indicative of when the program code to detect detects the request to initiate the call session;
program code to transmit a call invite message to the second terminal;
program code to receive a call answer from the second terminal in response to the call invite message;
program code to store second time information indicative of when the program code to receive receives the call answer; and
program code to send, from the first terminal, Post-Dial-Delay (PDD) information based on the first and second time information.

62. The first terminal of claim 61, wherein the program code to send sends the first and second time information as the PDD information.

63. The first terminal of claim 62, further comprising:
program code to calculate the PDD at the first terminal based on the first and second time information,
wherein the program code to send sends the calculated PDD as the PDD information.

64. The first terminal of claim 61, wherein the program code to send sends the PDD information within one or more signaling messages of a communication protocol that supports the call session.

65. A computer-readable medium comprising instructions, which, when executed by a server within a wireless communications network, cause the server to perform operations, the instructions comprising:
program code to receive at least one message from a first terminal that indicates Post Dial Delay (PDD) information related to a call session between the first terminal and a second terminal, the at least one message being a signaling message defined by a communication protocol associated with the call session;
program code to forward the at least one message to the second terminal; and
program code to extract, from the at least one message, the PDD information.

66. The computer-readable of claim 65, wherein the first terminal initiates the call session, the PDD information includes first time information and second time information, the first time information based on when a request to initiate the call session is detected at the first terminal, and the second time information based on when a call answer message is received from the second terminal at the first terminal.

67. The computer-readable of claim 66, further comprising:
program code to calculate the PDD of the call session based on the first and second time information.

68. The computer-readable of claim 65, wherein the received PDD information corresponds to a calculated PDD of the call session that is calculated at the first terminal.

69. The computer-readable of claim 65, wherein the at least one message corresponds to one or more signaling messages of a communication protocol that supports the call session.
